(19) United States
(12) Patent Application Publication
(10) Pub. No.: US 2014/0331406 A1
(43) Pub. Date: Nov. 13, 2014

(54) Patient Transportation Systems

(71) Applicants: Sultan Haider, Erlangen (DE); Ludwig Kreischer, Dormitz (DE)

(72) Inventors: Sultan Haider, Erlangen (DE); Ludwig Kreischer, Dormitz (DE)

(21) Appl. No.: 14/251,068

(22) Filed: Apr. 11, 2014

(30) Foreign Application Priority Data
May 10, 2013 (DE) DE 102013208610.5

(51) Int. Cl. A61G 13/12; A61G 7/08

(52) U.S. Cl. CPC A61G 13/128; A61G 7/08
USPC 5/600; 701/23

(57) ABSTRACT

A patient transportation system includes: a patient transportation device configured to dock with a medical instrument, the patient transportation device having a plurality of wheels; a registration apparatus configured to register information; and a control unit configured to change at least one wheel position of at least one wheel of the plurality of wheels based on information registered by the registration apparatus. The system may be used to assist operating staff when the patient transportation device approaches the medical instrument.

### RELATED APPLICATIONS

This application claims the benefit of German Patent Application No. DE 102013208610.5, filed May 10, 2013. The entire contents of the priority document are hereby incorporated herein by reference.

### TECHNICAL FIELD

The present teachings relate generally to patient transportation systems.

### BACKGROUND

In hospitals, patients may be transported between different diagnostic and therapeutic instruments, or between holding areas and examination rooms. Oftentimes, patients are transported in a lying position on a patient transportation device (e.g., a trolley). For diagnosis or treatment with a diagnostic or treatment instrument (e.g. computed tomography scanner, magnetic resonance imaging scanner, x-ray instrument, radiation therapy instrument, etc.), a patient may be moved from the patient transportation device to a space provided for the diagnosis or treatment procedure. The patient, who may be in a poor physical state, may be moved with minimum exertion on the part of the patient. Conventional patient transportation devices are, in part, configured for docking onto a medical instrument or a medical modality. For example, the patient transportation device may be fastened to the medical instrument in order to simplify repositioning of the patient.

Quick and efficient docking of a patient transportation device onto a medical instrument may reduce patient stress and prevent interruption of the medical workflow. United States Patent Application Publication No. US 2006/0167356 A1 describes a trolley that provides automatic assistance in the docking procedure. Sensors support the locking of the trolley onto a medical instrument, thereby facilitating the connection and minimizing difficulties encountered by operating staff.

### SUMMARY AND DESCRIPTION

The scope of the present invention is defined solely by the appended claims, and is not affected to any degree by the statements within this summary.

The present embodiments may obviate one or more of the drawbacks or limitations in the related art. For example, some embodiments may provide assistance to the operating staff when transporting patients by a patient transportation device.

A patient transportation system in accordance with the present teachings includes a patient transportation device (e.g., a trolley) with a plurality of wheels. The device is configured to dock onto a medical instrument or medical modality (e.g., computed tomography scanner, magnetic resonance imaging scanner, x-ray instrument, radiation therapy instrument, etc.).

Furthermore, the patient transportation system has a registration apparatus configured to register information. As used herein, the term “information” includes the registration of a plurality of items of information (e.g., individual associated or separate items of information). By way of example, the information may also be an image.

The patient transportation system also includes a control unit configured to change at least one wheel position of at least one wheel of the plurality of wheels based on information registered by the registration apparatus. The change in wheel position may involve a change in direction. The change in wheel position may also involve locking a wheel, thereby braking the patient transportation device. In some embodiments, the registration apparatus and the control unit may be part of the patient transportation device. In other embodiments, the registration apparatus and the control unit are not part of the patient transportation device.

In accordance with the present teachings, assistance may be provided for the docking procedure itself, and for the approach of the patient transportation device to the docking interface of the medical instrument. The operating staff may be assisted in bringing the transportation device to the interface provided for docking, thereby simplifying transportation and docking for medical examinations or treatments.

The information registered by the registration apparatus may contain directional information, distance information, movement information or a combination of thereof. In some embodiments, the information may not directly contain one of directional information, distance information, or movement information. Instead, directional information, distance information, movement information or a combination thereof may be obtained from the registered information by evaluation (e.g., by analyzing an image captured by a camera). By way of example, the directional information may include the direction to the docking interface of the medical instrument. The distance information may include the distance to the medical instrument. By way of example, both the directional information and the distance information are registered and used to calculate the wheel position. The movement produced by an operator moving or pushing the transportation device may be detected and used for setting the wheel position. By way of example, a movement sensor may detect braking by the operator and assist the braking by locking the wheels.

The registration apparatus may include one or more sensors configured to detect the information. The sensor may be an optical sensor (e.g., including a camera), a sensor operating on a capacitive basis, an ultrasound-based sensor, or an RFID-based sensor.

The patient transportation system may be identical to the patient transportation device. The registration apparatus may include a plurality of sensors that are arranged, in some embodiments, at the front end of and under the patient transportation device.

In other embodiments, the registration apparatus is not part of the patient transportation device. Rather, the registration apparatus is arranged in the vicinity of the medical instrument. The registration apparatus, for registration purposes, may be connected to a transmission device arranged externally to the patient transportation device. The connection may be physical but may also include a radio link. The transmission device may be configured to transmit control information to the patient transportation device. The patient transportation device may be equipped with a receiver configured to receive control information transmitted by the transmission device. To process or evaluate the information registered by the registration apparatus, a registration apparatus may be provided external to the patient transportation device. An evaluation device configured to evaluate or analyze the registered information may be connected to the registration apparatus that is arranged external to the patient device and may be connected to the transmission device. In some embodiments, the connection is not physical but may be achieved, for example, by telecommunication. The evaluation may include calculation of a direction from a recorded image. The evaluation device may be provided external to the patient transportation device in the case of a magnetic resonance imaging scanner to facilitate shielding of the evaluation device from magnetic fields.

In some embodiments, the patient transportation device includes a motor configured to interact with the control unit for changing the at least one wheel position. The motor may be further configured for driving the wheels and/or for adjusting the height of a patient bearing. Alternatively, one or two separate motors may also be provided for driving the wheels and/or for adjusting the height of a patient bearing.

The information registered by the registration apparatus may include a marking in the vicinity of the medical instrument or a camera image. The registration apparatus may be suitably arranged depending on the position and type of information to be registered. In some embodiments, a marking may be provided on the floor in the vicinity of the medical instrument, and the registration apparatus may be attached to the underside of the patient transportation device. The marking may be registered by the registration apparatus if the marking is situated underneath the patient transportation device in a registration region of the registration apparatus. The marking may include a line that allows continuous registration of a path to the medical instrument. Alternatively, a plurality of separate markings may be provided. The plurality of separate markings may be arranged at such a distance from one another that at least one marking is detected at all times in the registration region (e.g., a region that may be detected by one or more sensors of the registration apparatus). In some embodiments, the marking may include distance information relating to the distance between the patient transportation device and the medical instrument. The distance information may be provided to initiate an action (e.g. braking, directional adaptation, etc.) that relates to the docking of the patient transportation device onto the medical instrument.

In some embodiments, the patient transportation system includes a sensor (e.g. an ultrasound sensor) configured to establish the distance between the patient transportation device and the medical instrument. The patient transportation system may be configured to initiate an action (e.g. braking, directional adaptation, etc.) that relates to the docking of the patient transportation device onto the medical instrument based on the established distance.

In some embodiments, the patient transportation device includes a central wheel. The wheel position of the central wheel is controlled by the information. The central wheel may be coupled (e.g., mechanically) to one or more of the other wheels of the plurality of wheels. The wheel position of the coupled wheels may be adapted or set by the coupling based on the wheel position of the central wheel. In some embodiments, the central wheel may be provided in the form of a plurality of wheels (e.g., two) that may be selectively coupled to other wheels, thereby providing better control.

A mobile medical device in accordance with the present teachings may include features analogous to those described herein in connection with the patient transportation device.

A mobile medical instrument configured to dock a patient transportation device onto a medical instrument includes a plurality of wheels, a registration apparatus configured to register information, and a control unit configured to change at least one wheel position of at least one wheel of the plurality of wheels based on information registered by the registration apparatus.

### BRIEF DESCRIPTION OF THE DRAWINGS

FIG. 1 shows a perspective view of a docking device.

FIG. 2 shows an example of a patient transportation system.

FIG. 3 shows an example of the coupling of wheels in an exemplary patient transportation system.

FIG. 4 shows an example of a patient transportation system that includes a control system configured as a double wheel.

FIG. 5 shows an example of a patient transportation system configured for partial external registration of information.

FIG. 6 shows a schematic image of an example of a patient transportation device.

FIG. 7 shows a schematic image of an example of guiding an approach of an exemplary patient transportation device by a line marking.

FIG. 8 shows an example of an alternative marking system.

FIG. 9 shows an example of a system that includes an exemplary mobile medical instrument.

FIG. 10 shows an example of a system with a line marking that includes distance information.

### DETAILED DESCRIPTION

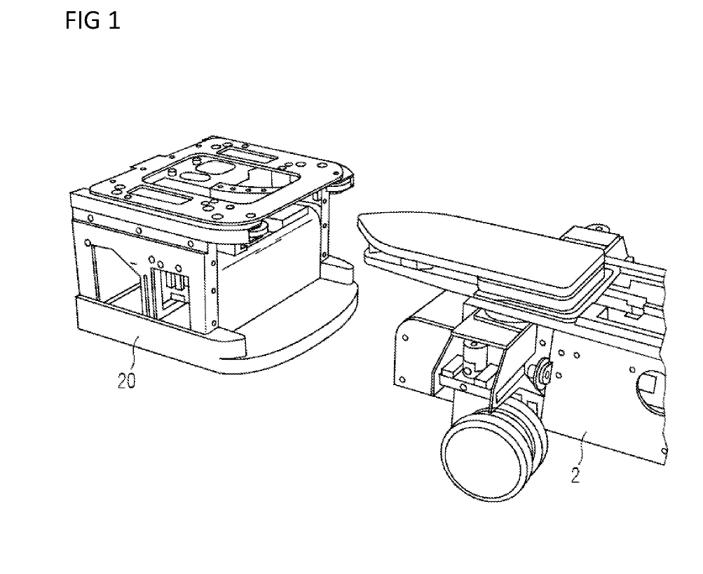

FIG. 1 shows the front docking region of a patient transportation device 2 and a docking module 20 fastened to a medical instrument (not shown). The components shown in FIG. 1 define a mechanical interface designed for locking the patient transportation device 2 on the medical instrument. The docking procedure has an associated outlay and is to be learned by the operating staff. For successful docking, the patient transportation device 2 is led to the docking module 20 at the correct position and at angle.

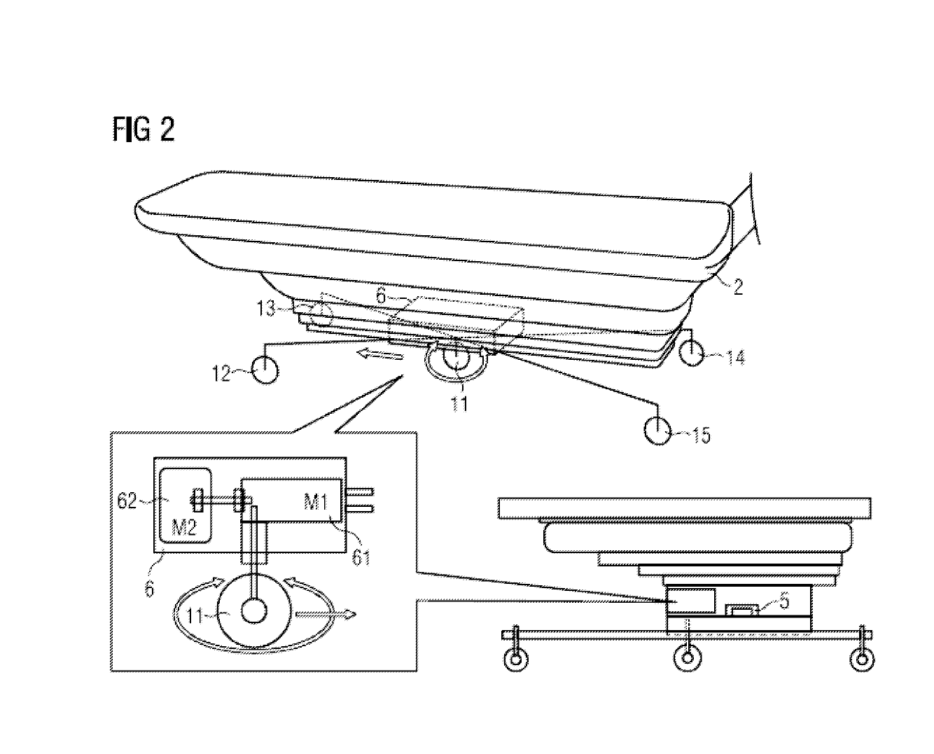

FIG. 2 shows a patient transportation device 2, configured in accordance with the present teachings. The control is implemented by a wheel 11 that is fastened to the central lower region of the patient transportation device 2. A motor unit 6 that contains first motor 61 and second motor 62 is situated over the wheel 11. The first motor 61 controls the position of the wheel 11 and the second motor 62 drives the wheel. Fastening the motor centrally in the lower region of the patient transportation device may facilitate docking onto a magnetic resonance imaging scanner since the positioning minimizes magnetic interference. The patient transportation device 2 contains a control device 5 (e.g. a microprocessor). The control commands for the motor unit 6 are generated by the control device 5. Additional wheels, such as first wheel 12, second wheel 13, third wheel 14, and fourth wheel 15, may be coupled to the central wheel 11.

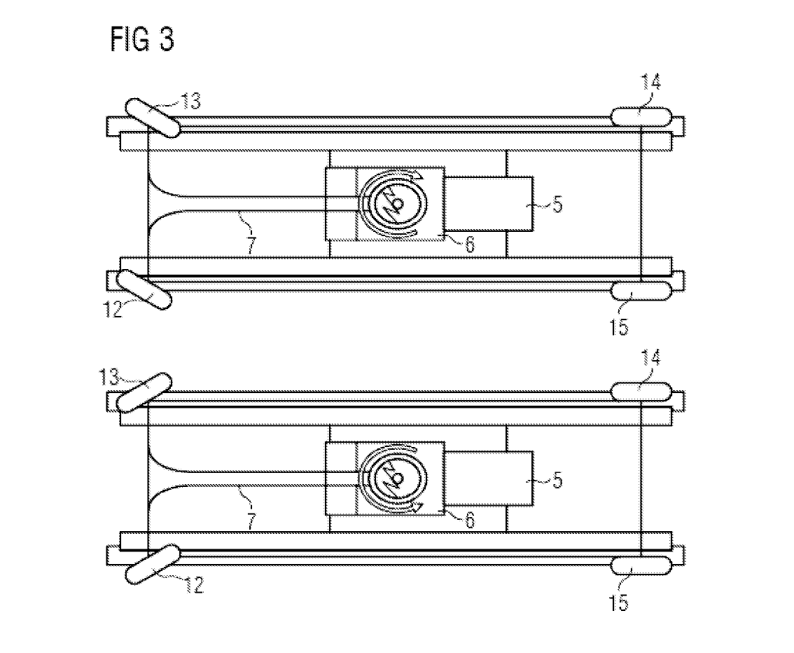

The coupling is shown in FIG. 3. The central wheel 11 is coupled to the first wheel 12 and the second wheel 13 by a coupling mechanism 7. The positions of the first wheel 12 and the second wheel 13 adapt based on the position of the central wheel 11. The motor component 6 changes the wheel position of the central wheel 11. Different motors for controlling and driving the wheels and for adjusting the height of the patient transportation device may be used. In some embodiments, one motor is used. In other embodiments, a plurality of motors is used.

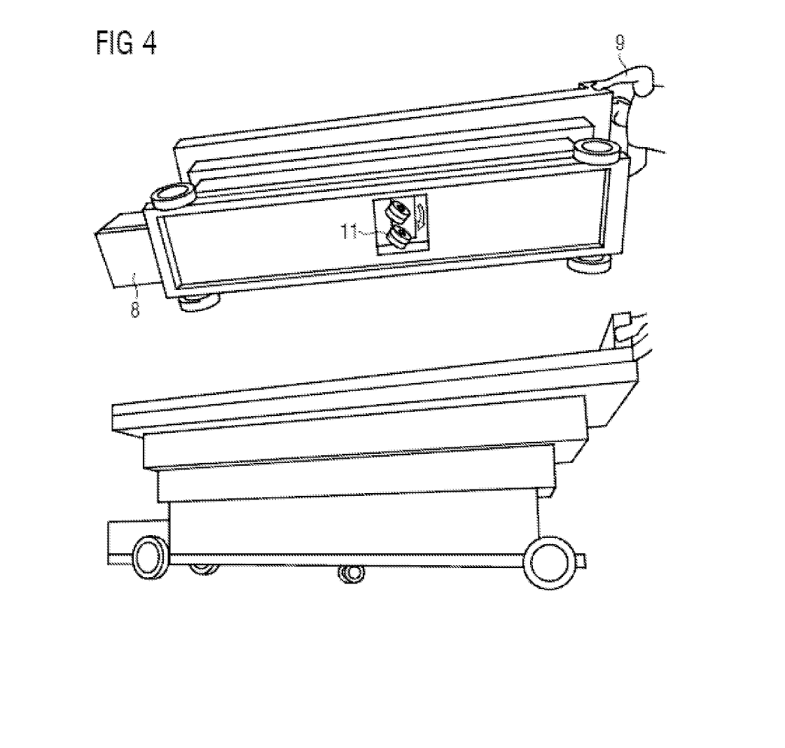

FIG. 4 shows an embodiment of the patient transportation device that includes a double wheel 11 in place of a single wheel. FIG. 4 also shows a component 8 for docking (e.g., a docking interface) and an operator 9. The patient transportation device may include movement sensors that assist the movement (e.g., direction or braking) produced by the operator 9.

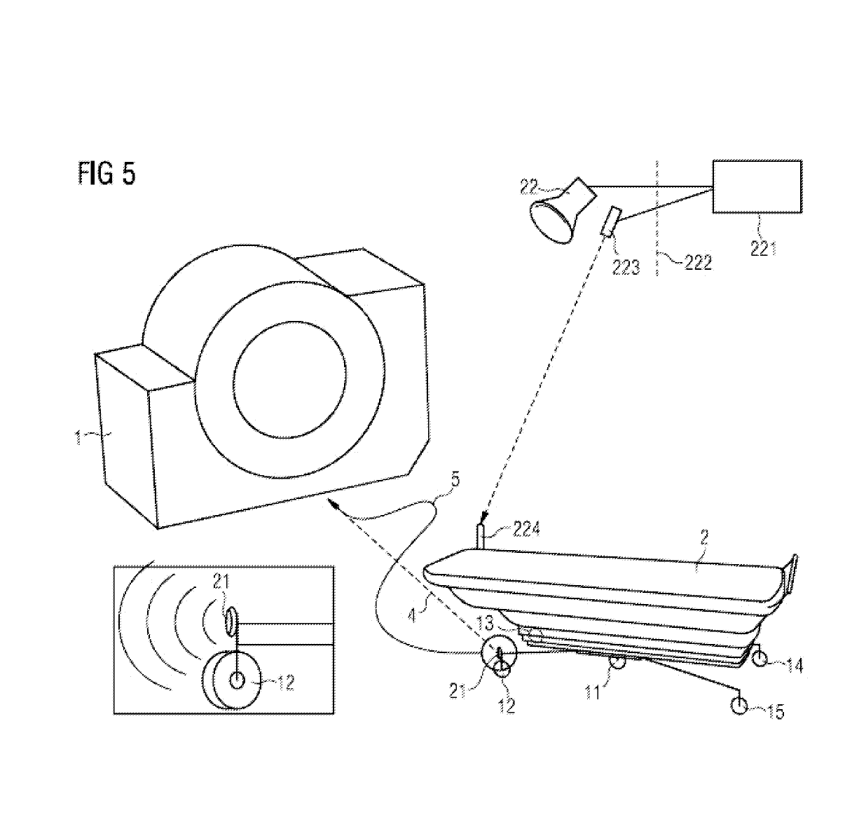

FIG. 5 shows a further embodiment of a patient transportation system in accordance with the present teachings. The patient transportation device 2 shown in FIG. 5 is configured to assist the approach to the medical modality 1 along a path 5. The patient device may be formed with a central wheel or a central pair of wheels 11. The central wheel or the central pair of wheels 11 may be coupled to other wheels, such as first wheel 12, second wheel 13, third wheel 14, and fifth wheel 15. The registration apparatus contains two subsystems. A first subsystem is fastened to the patient transportation device 2. The second subsystem is fastened external to the patient transportation device. The registration subsystem on the patient transportation device 2 includes a sensor 21 that determines a distance 4 from the medical modality 1 (e.g., using ultrasound). A camera 22 fastened close to the ceiling may be provided as an external registration subsystem. The camera 22 records an image of the patient transportation device 2 and the modality 1. The image is transmitted to an evaluation device 221 that is shielded from magnetic fields by a shield 222.

The evaluation device 221 determines or calculates control information (e.g., a current approach vector of the patient transportation system 2 and the deviation thereof from an ideal approach vector). The evaluation system 221 establishes control information (e.g. wheel position) and passes the control information to a transmitter 223 that transmits the control information wirelessly to the receiver 224 of the patient transportation device 2. The wheel position may be adapted on the basis of the control information.

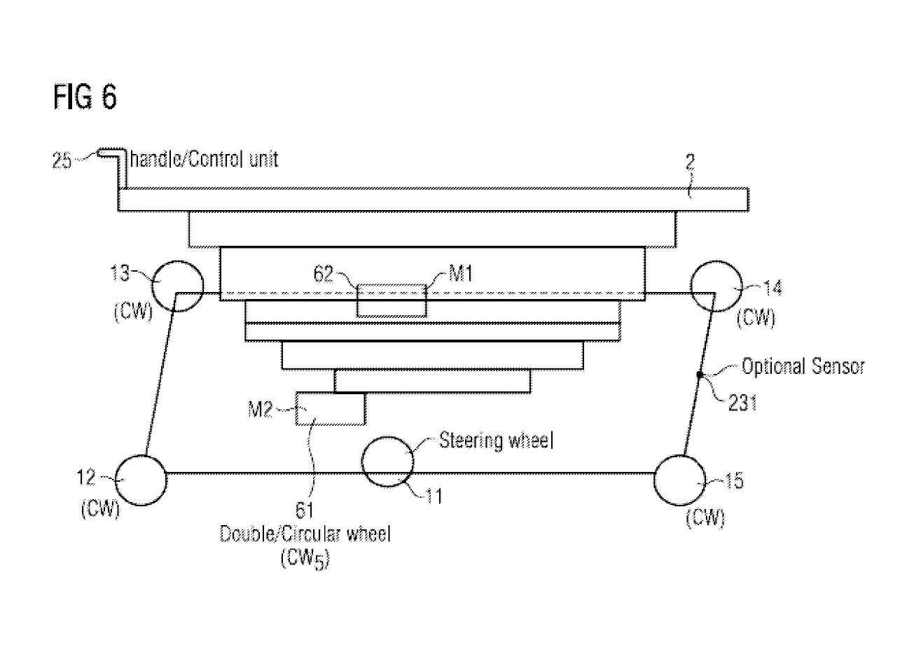

FIG. 6 shows a further embodiment of a patient transportation device 2 in accordance with the present teachings. The patient transportation device 2 includes a central wheel 11, first wheel 12, second wheel 13, third wheel 14, and fourth wheel 15. The transportation device 2 includes a handle 25 for manual movement. As shown in FIG. 6, the patient transportation device 2 includes first motor 61 and second motor 62. The first motor 61 sets the position of the central wheel 11. The second motor 62 controls height adjustment of the patient bearing. No motor is provided for the drive in the embodiment shown in FIG. 6 since the transportation device 2 is configured to be driven by operating staff. As shown in FIG. 6, the patient transportation device 2 contains an optical sensor 231 fastened on the underside at the front of the device and configured to detect floor markings.

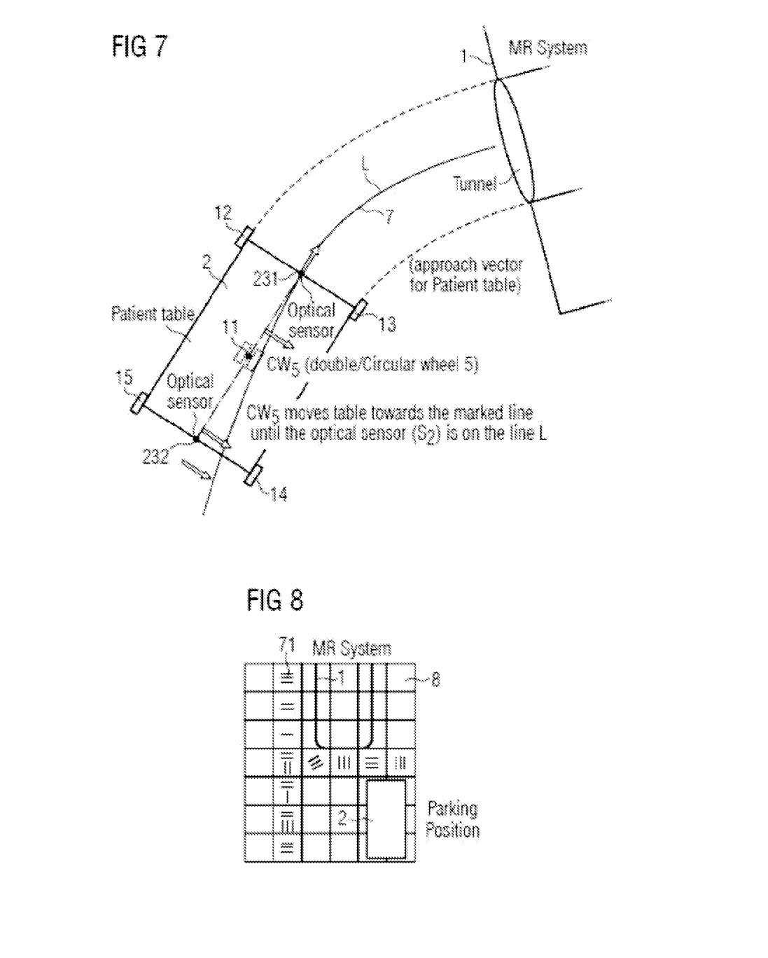

The use of floor markings is shown in more detail in FIGS. 7 and 8. In addition to the front optical sensor 231, the patient transportation device 2 shown in FIG. 7 optionally includes an additional optical sensor 234 that is likewise configured to detect floor markings. A marking 7 that specifies a transportation path to the medical instrument 1 is applied to the floor. The wheel positions of the central wheel 11 with the round configuration and of the coupled first wheel 12, second wheel 13, third wheel 14, and fourth wheel 15 are corrected based on the detected line 7, thereby providing automatic steering. Thus, the trolley 2 may be pushed by operating staff without manual steering. For embodiments containing an additional motorized drive, the trolley 2 may be automatically driven to the docking position without human intervention.

FIG. 8 shows an alternative marking for the line shown in FIG. 7. A schematic top view of an examination room is shown in FIG. 8. A first area 1 is occupied by a medical modality. The patient transportation device 2 is positioned at the lower right-hand corner of FIG. 8. The floor is subdivided into a plurality of sections 8. Sections 8 of the floor that are relevant to the approach include markings 71. The markings 71 are identified by sensors fastened to the underside of the patient transportation device 2. Alternatively, the sensors may be fastened externally to the ceiling and used to control the wheels of the patient transportation device 2. The individual markings 71 encode information about the position of the respective section 8 in relation to the docking point of the medical instrument 1.

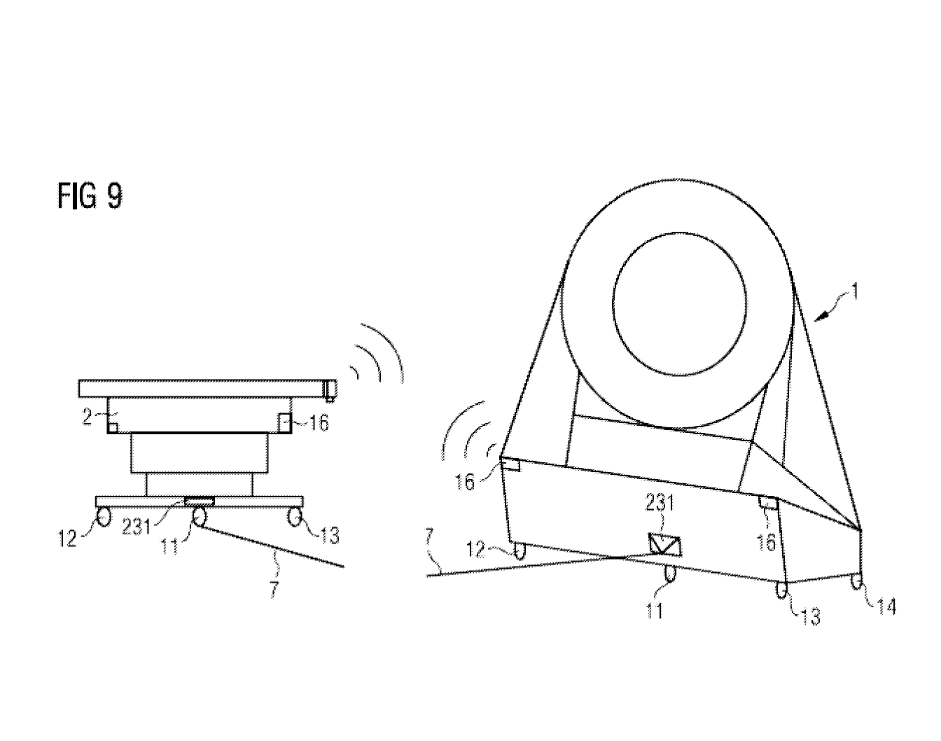

FIG. 9 shows a patient transportation device 2 and a mobile medical instrument 1 (e.g. a mobile computed tomography instrument). The patient transportation device 2 and the mobile medical instrument 1 are configured for movement control using lines 7 on the floor that may be optically registered. The patient transportation device 2 and the mobile medical instrument 1 each include an optical sensor 231 configured to optically register the lines 7. Moreover, each of the patient transportation device 2 and the mobile medical instrument 1 includes a central wheel 11 with control functionality, and each of the patient transportation device 2 and the mobile medical instrument 1 may include additional wheels, such as first wheel 12, second wheel 13, and third wheel 14. In addition, the patient transportation device 2 and the mobile medical instrument 1 each include an ultrasound sensor 16. The ultrasound sensor 16 may be used for measuring the distance. The distance established may in turn be used to initiate and control a docking procedure. By way of example, based on the distance, the velocity may be reduced, the docking interfaces may be activated, and the angle of approach may be adapted.

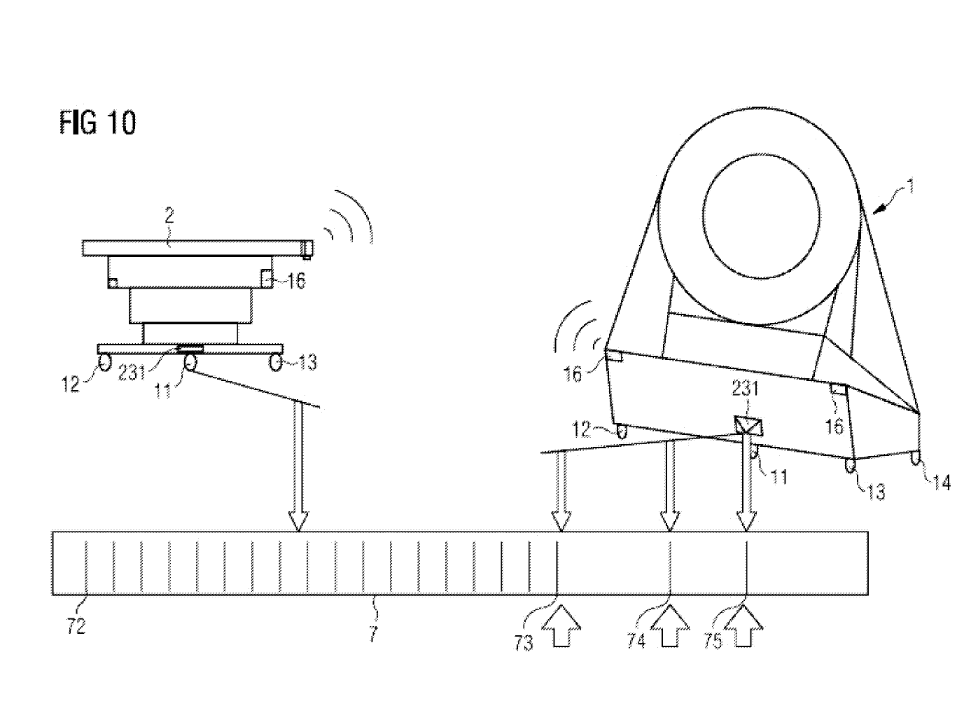

Alternatively, or in addition, the distance information for controlling the docking procedure may also be encoded into the guide line 7, as shown in more detail in FIG. 10. The guide line or marking line 7 may include detectable marking bars, such as a sequence of equidistant bars that contain a first bar 72 and a second bar 73, as shown in FIG. 10. Distance information that triggers the docking is encoded by the distance between bars. Between the third bar 73 and the fourth bar 74, bar spacing has increased in relation to the bar sequence. The increase in bar spacing is interpreted as a signal to initiate the docking procedure. For example, the velocity is reduced. The ultrasound sensors 16 are used to measure the distance, and the velocity is curbed as a function of the measured distance. The detection of the fourth bar 74 triggers the docking procedure. The next and final fifth bar 75 marks the end position for the docking procedure.

While the present invention has been described above by reference to various embodiments, it should be understood that many changes and modifications may be made to the described embodiments. It is therefore intended that the foregoing description be regarded as illustrative rather than limiting, and that it be understood that all equivalents and/or combinations of embodiments are intended to be included in this description.

It is to be understood that the elements and features recited in the appended claims may be combined in different ways to produce new claims that likewise fall within the scope of the present invention. Thus, whereas the dependent claims appended below depend from only a single independent or dependent claim, it is to be understood that these dependent claims may, alternatively, be made to depend in the alternative from any preceding claim—whether independent or dependent—and that such new combinations are to be understood as forming a part of the present specification.

1. A patient transportation system, comprising:
a patient transportation device configured to dock with a medical instrument, the patient transportation device comprising a plurality of wheels;
a registration apparatus configured to register information; and
a control unit configured to change at least one wheel position of at least one wheel of the plurality of wheels based on information registered by the registration apparatus.

2. The patient transportation system of claim 1, wherein the information comprises directional information, distance information, or movement information, or wherein directional information, distance information, or movement information are derivable from the information.

3. The patient transportation system of claim 1, wherein the registration apparatus comprises a sensor configured detect the information.

4. The patient transportation system of claim 1, wherein the registration apparatus is arranged on the patient transportation device or is proximal to the medical instrument.

5. The patient transportation system of claim 4, wherein:
the registration apparatus is proximal to the medical instrument;
the registration apparatus is connected to a transmission device external to the patient transportation device;
the transmission device is configured to transmit control information to the patient transportation device; and
the patient transportation device comprises a receiver configured to receive the control information transmitted by the transmission device.

6. The patient transportation system of claim 5, wherein:
the control information comprises the registered information or the control information is connected to the registered information by an evaluation device;
the evaluation device is external to the patient transportation device; and
the evaluation device is connected to the registration apparatus and the transmission device.

7. The patient transportation system of claim 6, wherein the evaluation device is shielded against magnetic fields.

8. The patient transportation system of claim 1, further comprising a plurality of registration apparatuses.

9. The patient transportation system of claim 1, wherein the patient transportation device comprises a motor configured to interact with the control unit for changing the at least one wheel position.

10. The patient transportation system of claim 9, wherein the motor is further configured to drive the plurality of wheels, to adjust a height of a patient-bearing surface, or to drive the plurality of wheels and to adjust the height of the patient-bearing surface.

11. The patient transportation system of claim 1, wherein the information comprises a marking proximal to the medical instrument or a camera image, and wherein the registration apparatus is configured to register the marking or the camera image.

12. The patient transportation system of claim 11, wherein the marking is applied to the floor and the registration apparatus is attached to an underside of the patient transportation device, such that the registration apparatus is configured to register the marking if the marking is situated underneath the patient transportation device in a registration region of the registration apparatus.

13. The patient transportation system of claim 11, wherein:
the marking comprises distance information relating to a distance between the patient transportation device and the medical instrument; and
the patient transportation system is configured to initiate an action that relates to the docking of the patient transportation device with the medical instrument based on the distance information.

14. The patient transportation system of claim 1, wherein:
the patient transportation system further comprises a sensor configured to establish a distance between the patient transportation device and the medical instrument; and
the patient transportation system is configured to initiate an action that relates to the docking of the patient transportation device with the medical instrument based on the established distance.

15. The patient transportation system of claim 1, wherein the patient transportation device comprises a central wheel, and wherein a wheel position of the central wheel is controlled by the information.

16. The patient transportation system of claim 15, wherein the central wheel is coupled to one or more additional wheels of the plurality of wheels, and wherein a wheel position of a coupled wheel is adaptable based on the wheel position of the central wheel.

17. The patient transportation system of claim 15, further comprising a plurality of central wheels.

18. A mobile medical instrument configured to dock with a patient transportation device, the mobile medical instrument comprising:
a plurality of wheels;
a registration apparatus configured to register information; and
a control unit configured to change at least one wheel position of at least one wheel of the plurality of wheels based on information registered by the registration apparatus.

19. The mobile medical instrument of claim 18, wherein:
the information comprises directional information, distance information, or movement information, or wherein directional information, distance information, or movement information are derivable from the information; and
the registration apparatus comprises a sensor configured to detect the information.

20. The mobile medical instrument of claim 18, wherein the information comprises a marking proximal to the medical instrument or a camera image, and wherein the registration apparatus is configured to register the marking or the camera image.
